(19) United States
(12) Patent Application Publication
(10) Pub. No.: US 2020/0094265 A1
(43) Pub. Date: Mar. 26, 2020

(54) METHOD FOR TREATING A SALT SOLUTION USING MULTISTAGE SEPARATION PROCESSES, AND TREATMENT SYSTEM FOR THIS PURPOSE

(71) Applicant: K+S Aktiengesellschaft, Kassel (DE)

(72) Inventors: Jochen BROD, Landershausen (DE); Uwe Wachsmuth, Bad Sooden-Allendorf (DE); Anja Ringe, Ludwigshau (DE)

(73) Assignee: K+S Aktiengesellschaft, Kassel (DE)

(21) Appl. No.: 16/495,538

(22) PCT Filed: Mar. 19, 2018
(86) PCT No.: PCT/DE2018/000068

§ 371 Date: Sep. 19, 2019

(30) Foreign Application Priority Data
Mar. 20, 2017 (DE) 10 2017 105 881.8

(51) Int. Cl. B03D 1/02; B07B 13/04; B01D 21/26; B01D 9/00; C01D 5/12

(52) U.S. Cl. CPC B03D 1/02; B07B 13/04; B01D 21/267; B03D 2203/10; B01D 9/0018; C01D 5/12; B01D 21/265

(57) ABSTRACT

A method is used for treating a salt solution using a treatment system. The treatment system has an evaporation device to which the salt solution produced in an upstream operation is supplied. A crystallizate suspension having kainite, halite, and sylvite is obtained from the evaporation device, and the kainite is then separated from the crystallizate suspension. The method for separating the kainite from the crystallizate suspension has at least the following steps: supplying the crystallizate suspension to a preliminary classifying device in which kainite is partly separated from the crystallizate suspension by means of a preliminary removal process based on the particle size of the kainite, thereby obtaining a kainite-reduced fraction, and transferring the kainite-reduced fraction to a flotation device in which the remaining content of kainite is separated from the kainite-reduced fraction.

The invention relates to a method for treating a salt solution with a treatment system, where the treatment system comprises an evaporating device which is supplied with the salt solution formed in an upstream operation and from which a crystallizate suspension is obtained that comprises kainite, halite and sylvine, and where subsequently the kainite is at least partly removed from the crystallizate suspension.

### PRIOR ART

Crude potash salts which, as mixed salts, include considerable proportions of kainite are difficult to treat according to existing knowledge. There is currently no industrial treatment for the selective extraction of kainite from mineral mixtures by means of the flotation process. A selective extraction of kainite, however, allows the profitable onward processing of the kainite fraction into potassium sulfate products, which represent saleable products. Kainite, however, can also be used directly, for example, as a fertilizer or as a thawing agent.

“Aufbereitung fester Rohstoff, volume 11: Sortierprozesse, Deutscher Verlag für Grundstoffindustrie, Schubert, 1996, describes the flotation of kainite in solutions corresponding to the existence domain of the kainite. In this case, n-alkylammonium salts of chain length C8 to C12 are used as collectors, and aliphatic and aromatic alcohols as frothers. The flotation of kainite in the existence domain of sylvine is possible with the same collectors, in which case the kainite floats together with the sylvine. The kainite may then be separated from the sylvine in a second step using alkyl sulfates or alkane-sulfonates and also mixtures of branched-chain primary or secondary ammonium salts, with addition of small amounts of n-alkylammonium salts. “Potassium Salt Flotation from Great Salt Lake Evaporites”, Transactions Society of Mining Engineers, Huiatt, Tipyin and Potter, vol. 258, 303-310/1975 describes kainite as being unfloatable using dodecylammonium chloride and sodium dodecylsulfonate as flotation agents.

In “The Flotation chemistry of potassium double salts: Schoenite, Kainite and Camallite”, Materials Engineering, Vol. 13, No. 14-15, 1483-1493/2000, Hancer et al. describe the lack of success in kainite flotation using either fatty acids or alkylammonium salts as collectors.

“Reagenzsysteme in der Flotation Iöslicher Salze, Neue Bergbautechnik”, KOhler and Kramer, vol. 11, no. 6, 362-366/1981 describes the treatment of a crude polymineral salt (Stebnik, former Soviet Union), consisting of kainite (25%), langbeinite (10%), halite (35%), sylvine, polyhalite, and clayey constituents, with waterglass and polyacrylamide as clay suppressors, and the use of a fatty acid mixture of chain lengths C7 to C9 at up to 650 g/t. In this case, all of the sulfatic components are discharged in unison into the foam. Further, the authors determine only the arithmetic proportion of K₂SO₄ and MgSO₄ in the foam, and do not report any mineral phase analysis of the foam composition, of the consequence that in this case there may be any sulfatic salts (e.g., kainite, langbeinite) in the foam. With this method there is no selective kainite flotation. A mineral phase-specific flotation is not described.

In Hancock, Meacham McLaughlin (1993), p. 105 and in “The Flotation chemistry of potassium double salts: Schoenite, Kainite and Camallite”, Materials Engineering, Hancer et al., Vol. 13, No. 14-15, 1483-1493/2000, it is said that kainite is difficult to float and must be converted into other salts such as schoenite, on account of the better floatability of schoenite. Direct flotation of the kainite is not described here.

Particularly in freshly crystallized kainite mixtures, a first removal of at least one other salt mineral (e.g., sylvine, halite) is not successful. In freshly crystallized mixtures, the kainite present is very fine (for example, d₅₀<40 μm), while the sylvine and halite minerals present are coarser (for example d₅₀>40 μm). Reverse flotation of the halite (using N-alkylmorpholine, for example Armoflote 619 from Akzo Nobel) is unsuccessful, because the fine kainite is located likewise in the foam fraction, and so the only separations achievable are inadequate. Flotation with fatty amines (for example Genamin SH100 from Clariant or Rofamin R from DHW or similar) has the effect that the sylvine is discharged in the foam fraction, with this fraction, however, then additionally containing some kainite. Neither selective removal of the sylvine nor of the halite from the other respective mixture constituents is possible in this case.

DE 10 2014 017 645 A1 discloses a process for the selective flotation of kainite from crude potash salts or else, for example, from crystallizate suspensions obtained by evaporation methods and possibly containing, other than kainite, further minerals such as halite, sylvine and other salt minerals, for example, using a combination of conditioning agents consisting of sulfated fatty acids or alkali metal salts thereof, as collector reagents, and a frother which is known for the flotation process. For this purpose it is proposed that the ground or crystallized salt mixture be mixed intensively with a combination of conditioning agents consisting of a sulfated fatty acid or alkali metal salt thereof as collector reagent and of a frother known for flotation, in a flotation solution, and then be separated by agitator or pneumatic flotation into a kainite concentrate fraction and a residue fraction. It is said in particular that the crystallizate suspension obtained by the evaporation method and consisting of freshly prepared kainite/sylvine/halite salt solutions is used as a starting material.

In freshly crystallized mixtures, disadvantageously, the kainite present is very fine, with particle sizes, for example, of less than 40 μm (d₅₀), while the sylvine and halite minerals present are coarser, (for example, with particle sizes of more than 40 μm (d₅₀). The fine-particled kainite with its high specific surface area resulting from its fine particularity (d₅₀ around 35-40 μm), and the large amounts of kainite in the crystallizate suspension, place a substantial burden on the flotation in the context of the flotation feed. To ensure satisfactory kainite yields, a multistage flotation is necessary for this reason, and substantial quantities of conditioning agents have to be used in the flotation. Owing to the use of relatively large amounts of conditioning agents, this leads to higher costs for this mode of operation, and the cost and complexity of apparatus required are considerably higher.

While a good kainite selectivity for flotation treatment can be achieved, a single-stage flotation is frequently not sufficient to ensure satisfactory derivation of value from the feed material, owing in particular to the high kainite contents of the evaporation crystallizate.

### DISCLOSURE OF THE INVENTION

It is therefore an object of the present invention to provide a method for treating a salt solution with a treatment system so that the flotation is burdened to a lesser degree in the flotation device, and with which only relatively small quantities of conditioning agents are required. It is desirable in this case to achieve a significant reduction in the cost and complexity of apparatus, and thereby to obtain technical, economic and environmental advantages.

This object is achieved, starting from a method for treating a salt solution with a treatment system in accordance with the preamble of claim 1, and starting from a treatment system as claimed in claim 10, in conjunction with the respective characterizing features. Further advantageous embodiments of the invention are specified in the dependent claims.

The method of the invention envisages the following steps: supplying the crystallizate suspension to a preliminary classifying device, in which kainite is partly removed from the crystallizate suspension by means of a preliminary removal procedure based on the particle size of the kainite, to give a kainite-reduced fraction, and transferring the kainite-reduced fraction to a flotation device, in which the remaining proportion of kainite is removed at least predominantly from the kainite-reduced fraction.

The core concept of the invention is that of exploiting the different particle sizes of the minerals resulting from the crystallization—the more finely particulate kainite on the one hand and the more coarsely particulate sylvine and halite on the other.

In accordance with the invention, the preliminary classifier, namely a first separation of the kainite by means of a separation on the basis of particle size differences prior to the flotation, significantly relieves the burden on the flotation operation, and fewer flotation stages are necessary, and conditioning agent usage can be lessened, with consequent significant technical, economic, and environmental advantages.

The preliminary classifying diminishes the kainite value in the crystallizate suspension. This operation furnishes a kainite-rich fraction, with small amounts of halite and sylvine, and also a fraction which contains significantly reduced proportions of kainite and significantly higher proportions of halite and sylvine. The kainite-rich fraction, which has a chlorine content of ≤8%, can be utilized for further treatment and processing into products, and the kainite can be used as a useful substance. The kainite-depleted fraction, containing significantly less kainite than the feed to the preliminary classifier (crystallizate suspension), is then supplied to the actual flotation operation, for kainite flotation. The flotation produces a kainite concentrate, which with further advantage is combined with the above-described kainite-rich fraction from the preliminary classifier and can be utilized for further treatment and processing into products. The kainite flotation is performed by supplying the supplied kainite-reduced fraction, before or in the flotation device, with an anionic flotation assistant, such as a sulfated fatty acid or alkali metal salt thereof, for example; because of the prior preliminary classifying of the crystallizate suspension using the preliminary classifying device, the amounts of anionic flotation assistant such as, for example, a sulfated fatty acid or alkali metal salt thereof that must be supplied are significantly lower.

Furthermore, the kainite flotation produces a residue fraction which is significantly enriched in sylvine and halite and which can be used for further treatment and processing into products (e.g., KCl fertilizers).

Within the context of the invention, a sequential flotation may be employed for this purpose. The first flotation in the sequence is formed by the above-described kainite flotation, and the subsequent sequential flotation is formed by a sylvine flotation. Accordingly, it is possible for the flotation residue from the flotation device for kainite flotation to be supplied to a further flotation device for sylvine flotation. In that case the flotation residue from the first flotation device, before or in the further flotation device, may be supplied with a cationic flotation assistant, such as a primary amine, for example. A sylvine-reduced and halite-enriched first fraction and a sylvine-enriched and halite-reduced second fraction can be removed from the further flotation device. The second fraction, which is enriched in sylvine and reduced in halite, may find use, for example, in the manufacture of fertilizers, in which case it is possible to exploit the particular advantage that the proportion of halite in the second fraction is considerably reduced. The sylvine-reduced and halite-enriched first fraction can be disposed of.

A core concept of the inventive development of the method is the sequential flotation, with which the useful minerals kainite and sylvine are further separated from the mineral conglomerate of kainite-sylvine-halite (e.g., KCF crystallizate). With the sequential flotation, flotation of kainite is followed by reconditioning of the resultant residue fraction, with sylvine flotation in a further step. Surprisingly it has been found that the residue fraction can be reconditioned by simple addition of a cationic flotation assistant for the sylvine flotation, such as a primary amine, for example. This has been confirmed by high sylvine yields and sylvine contents in the concentrate fraction (second fraction) in the case of sylvine flotation. The high degree of separation is especially surprising since in the case of the kainite flotation, in the first step, an anionic flotation agent, such as a sulfated fatty acid, and in the subsequent sylvine flotation a cationic flotation agent, such as a primary amine, for example, can be used, the assumption being that these two flotation agents may form salts or react with one another.

With reference to the upstream preliminary classifying device, the classifying method employed here may be accomplished by means of various apparatuses and technologies known in the technology of treatment of mineral raw materials. For example, the preliminary classifying device comprises a sorting spiral, and the kainite is removed from the crystallizate suspension by means of a preliminary removal process based on the particle size of the kainite, by means of the sorting spiral. One possible embodiment of the sorting spiral has a diameter of one meter and possesses a height of four meters, with a total, for example, of seven turns of the sorting spiral. The kainite is separated on the basis of the difference in particle size in relation to the sylvine and halite.

Alternatively or additionally, the possibility exists for the preliminary classifying device to comprise a hydrocydone, in which case the kainite is removed from the crystallizate suspension by means of a preliminary removal process based on the particle size of the kainite, by means of the hydrocyclone. One possible embodiment of the hydrocyclone has a height of around 1 m and possesses a diameter of 0.2 m, the suspension being supplied to the hydrocyclone under pressure. Accordingly, the coarser particles, namely the sylvine and halite, eventually settle in the lower region, and the kainite can be taken off in the upper region.

In turn alternatively or additionally, the possibility exists for the preliminary classifying device to comprise an up-current classifier, in which case the kainite is removed from the crystallizate suspension by means of a preliminary removal process based on the particle size of the kainite, by means of the up-current classifier. One possible embodiment of the up-current classifier comprises a container into which the crystallizate suspension is fed and in which there is an upflowing solution, the up-current velocity of the upflow solution with the crystallizate suspension being selected so as to enable the coarser sylvine and halite to be taken off at the bottom side, and the kainite to be taken off at the top side.

According to a further advantageous embodiment of the method, a kainite-enriched fraction is transferred from the preliminary classifying device into a thickening device, in which liquid is taken off from the kainite-enriched fraction, and so a useful kainite fraction is taken out from the thickening device. In particular, a kainite concentrate is taken out from the flotation device and supplied to the useful kainite fraction. It is further possible for a flotation residue comprising halite and sylvine to be taken out from the flotation device and supplied to a secondary treatment device, such as a dissolution facility or a further flotation device, for example.

The invention is further directed to a treatment system for implementing a method for treating salt solutions as described above, comprising a preliminary classifying device and a flotation device downstream of the preliminary classifying device.

### PREFERRED EXEMPLARY EMBODIMENT OF THE INVENTION

Further measures, improving the invention, are set out in more detail below, together with the description of a preferred exemplary embodiment of the invention using the figures, in which

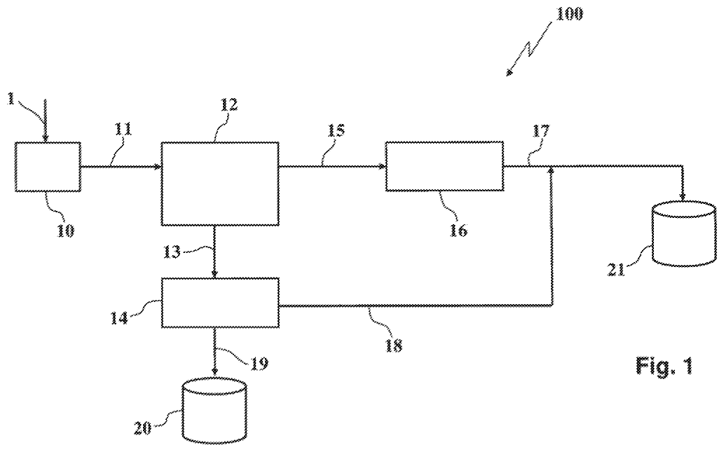

FIG. 1 shows a schematic view of the treatment system for implementing a method for treating salt solutions in accordance with the invention, and

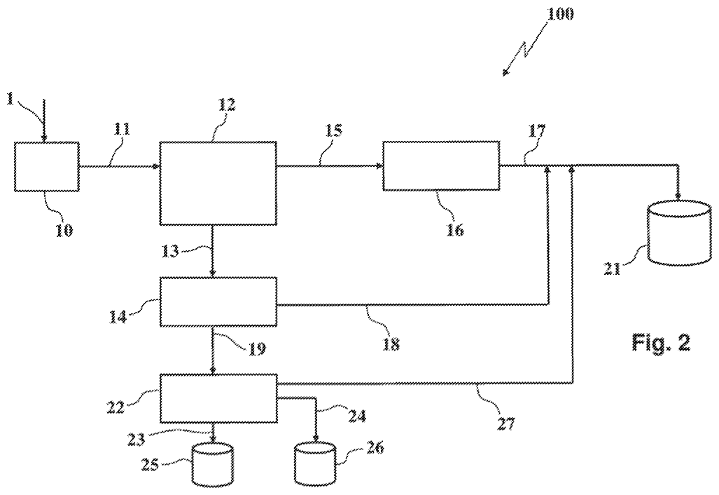

FIG. 2 shows a further schematic view of the treatment system in accordance with FIG. 1, with a sequential flotation, comprising a first flotation device for kainite flotation and a further, second flotation device for sylvine flotation.

FIGS. 1 and 2 show a schematic view of a treatment system 100, where the treatment system 100 comprises an evaporating device 10, which is supplied with the salt solution 1 formed in an upstream operation and from which a crystallizate suspension 11 comprising kainite, halite, and sylvine is obtained, and where subsequently the kainite is at least partly removed from the crystallizate suspension 11.

In this case, the crystallizate suspension 11 is first supplied to a preliminary classifying device 12, in which kainite is partly removed from the crystallizate suspension 11 by means of a preliminary removal process based on the particle size of the kainite, to give a kainite-reduced fraction 13. The kainite-reduced fraction 13 is subsequently transferred to a flotation device 14, in which the remaining proportion of kainite is removed, especially predominantly removed, from the kainite-reduced fraction 13.

The preliminary classifying device 12 comprises, for example, a sorting spiral, in which case the kainite is removed from the crystallizate suspension 11 by means of a preliminary removal process based on the particle size of the kainite, by means of the sorting spiral. Further details of this are set out below.

Furthermore, a kainite-enriched fraction 15 is transferred from the preliminary classifying device 12 into a thickening device 16, in which liquid is taken off from the kainite-enriched fraction 15, and so a useful kainite fraction 17 is taken out from the thickening device 16, said fraction 17 being reduced in liquid and being transferred, for example, into a reservoir 21.

With particular advantage a kainite concentrate 18 is taken out from the flotation device 14, and this kainite concentrate 18 is supplied to the useful kainite fraction 17. The supplying therefore takes place after the thickening device 16, and so the kainite concentrate 18 as well can be supplied to the reservoir 21. This reservoir 21 is not absolutely necessary, and the useful kainite fraction 17 in conjunction with the kainite concentrate 18 may also be supplied directly to a further dewatering and/or further-processing system, in order, for example, to produce potassium sulfate fertilizer.

With reference to FIG. 1, a flotation residue 19 comprising halite, sylvine, and possibly residues of kainite is taken out from the flotation device 14 and supplied, by way of example, to a reservoir 20; the flotation residue 19 may also be supplied, directly or from the reservoir 20, to a further, otherwise undepicted secondary treatment process, such as a dissolution facility, for example.

With reference to FIG. 2, a flotation residue 19 comprising halite, sylvine, and possibly residues of kainite is taken out from the flotation device 14 and supplied to a further flotation device 22. In the further flotation device 22, a sylvine flotation takes place, from which a sylvine-reduced and halite-enriched first fraction 23 and a sylvine-enriched and halite-reduced second fraction 24 are removed. The advantage is in particular that, in the case of sylvine flotation with primary amines, kainite still present can be floated out along with the sylvine, and so enters the product fraction.

The first fraction 23 can be disposed of, and for this purpose is supplied, by way of example, to a reservoir 25, and the second fraction 24, which contains essentially sylvine and has merely remnants of halite and also kainite, can be used for the manufacture of fertilizers. The second fraction 24 in this case is supplied, by way of example, to a reservoir 26 for further use, or can be combined with the fraction of the kainite concentrate 18 from the kainite flotation stage from the flotation device 14, as indicated with the return line 27. A further possibility is for the second fraction 24 to be supplied to a further, otherwise undepicted secondary treatment process, such as, for example, a dissolution facility, or to further flotation steps.

Considered in more detail below are two classifying methods using the preliminary classifying device 12. The first embodiment relates to preliminary removal by a sorting spiral, and the second embodiment relates to preliminary removal by a hydrocyclone, with which sorting spiral/hydrocyclone the preliminary classifying device 12 is accomplished.

With regard to the “sorting spiral” embodiment, trials were carried out on the preliminary classifier. Tables 1 and 2 below show the trial results for the classifying of the crystallizate suspension feed, consisting of kainite (47.4%), halite (38.3%), and sylvine (14.3%), by means of the sorting spiral. Trial 1 was aimed at a mode of operation for “kainite yield”, trial 2 at a mode of operation for “kainite quality”, in which case the target kainite content is high. Both modes of operation were tried twice (a/b).

The results show a significant enrichment of kainite in relation to the crystallizate suspension, and therefore a depletion in the fraction still to be floated, the kainite-impoverished fraction, so resulting in the advantages described above. Depending on the mode of operation of the sorting spiral, kainite qualities of between 80% and 86% were obtained. The yield of kainite in the kainite-enriched fraction here was between 24% and 30%. The halite content of the kainite fraction was found to be ≤8%, the values being reported in percent by weight.

TABLE 1
Results for classifying using sorting spiral
(Operation optimized for yield)

| | Trial 1a | | Trial 1b | |
|---|---|---|---|---|
| | Kainite- | Kainite- | Kainite- | Kainite- |
| | enriched | impoverished | enriched | impoverished |
| in [% by wt.] | fraction | fraction | fraction | fraction |
| Mass yields | 16.3 | 83.7 | 17.1 | 82.9 |
| Kainite content | 80.8 | 40.3 | 81.2 | 39.9 |
| R(kainite) | 28 | 72 | 30 | 70 |
| Halite content | 7.9 | 44.4 | 8.0 | 44.5 |
| R(halite) | 3 | 97 | 4 | 96 |
| Sylvine content | 11.3 | 15.3 | 10.9 | 15.5 |
| R(sylvine) | 13 | 87 | 13 | 87 |

R(mineral) = Yield of(mineral)

TABLE 2
Results for classifying using sorting spiral
(Operation optimized for quality)

| | Trial 2a | | Trial 2b | |
|---|---|---|---|---|
| | Kainite- | Kainite- | Kainite- | Kainite- |
| | enriched | impoverished | enriched | impoverished |
| in [% by wt.] | fraction | fraction | fraction | fraction |
| Mass yields | 14.2 | 85.8 | 13.6 | 86.4 |
| Kainite | 85.8 | 40.7 | 85.6 | 41.9 |
| content | | | | |
| R(kainite) | 26 | 74 | 24 | 76 |
| Halite | 5.1 | 43.9 | 5.6 | 43.2 |
| content | | | | |
| R(halite) | 2 | 98 | 2 | 98 |
| Sylvine | 9.1 | 15.4 | 8.8 | 14.9 |
| content | | | | |
| R(sylvine) | 9 | 91 | 9 | 91 |

R(mineral) = Yield of(mineral)

In order to reproduce the trials obtained by means of the sorting spiral, further trials were conducted with a continuous mode of operation. The results for this are set out in table 3.

TABLE 3
Results for kainite classification using sorting spiral with continuous operation

| | | | | | | | Kainite |
|---|---|---|---|---|---|---|---|
| | Kainite | Kainite | Yield of | | Halite | Sylvine | content |
| | content | content | useful | Mass | content | content | [% by |
| | [% by | [% by | substance | yield | [% by | [% by | wt.] |
| | wt.] | wt.] | [% by | [% by | wt.] | wt.] | Flotation |
| Trial | Feed | Concentrate | wt.] | wt.] | Concentrate | Concentrate | fraction |
| 3 | 51.7 | 81.6 | 30.5 | 19.3 | 6.0 | 12.5 | 44.6 |
| 4 | 52.6 | 80.4 | 26.9 | 17.6 | 6.3 | 13.3 | 46.7 |
| 5 | 47.8 | 84.7 | 16.5 | 9.3 | 3.6 | 11.7 | 44.0 |
| 6 | 46.4 | 84.2 | 16.5 | 9.1 | 4.3 | 11.5 | 42.6 |
| 7 | 48.2 | 79.3 | 36.4 | 22.2 | 7.7 | 13.0 | 39.4 |
| 8 | 48.5 | 79.8 | 35.5 | 21.6 | 7.5 | 12.8 | 39.9 |
| 9 | 73.0 | 90.5 | 46.8 | 37.7 | 5.3 | 4.2 | 62.4 |
| 10 | 67.5 | 89.2 | 43.9 | 33.2 | 6.3 | 4.5 | 56.7 |
| 11 | 67.3 | 88.9 | 52.7 | 39.9 | 6.5 | 4.6 | 52.9 |
| 12 | 56.8 | 91.2 | 30.9 | 18.3 | 5.1 | 3.7 | 45.5 |
| 13 | 58.6 | 90.1 | 26.5 | 17.2 | 4.9 | 5.0 | 52.0 |
| 14 | 65.7 | 89.4 | 51.0 | 37.5 | 5.9 | 5.0 | 51.4 |
| 15 | 64.8 | 90.1 | 45.1 | 32.5 | 4.9 | 5.0 | 52.7 |

In the context of the trials carried out by means of the sorting spiral, a removal is possible in which at least 20% of the total amount of crystallizate can be removed with the required concentrate quality (table 3).

In the course of the trials, concentrate fractions having a halite content of ≤8% were obtained. The concentrate quality in terms of the kainite content in this case was around 80%-91%, and the yield of useful substance was between around 16% and 53%, depending on the parameter setting of the spiral.

These results as well show a significant enrichment of the kainite in the concentrate fraction in relation to the feed crystallizate, and therefore a depletion in the fraction still to be floated, in other words in the kainite-impoverished fraction. It was observed, indeed, that in the case of relatively high kainite contents in the feed, the preliminary removal tends to be better in terms of the yield of useful substance.

The trials relating to classification by means of a hydrocyclone in the preliminary classifying device 12 likewise show the possibility of selective kainite enrichment in principle even with relatively high halite contents (and relatively low kainite contents) in the crystallizate suspension.

In the classification, primarily kainite is obtained in the overflow fraction of the hydrocyclone, and primarily halite and/or sylvine, and reduced proportions of kainite, in the underflow fraction. The results in this regard are shown in table 4 below.

TABLE 4
Results for the classification using a hydrocyclone

| Mineral phase | | Cyclone | Cyclone |
|---|---|---|---|
| distribution | Feed A | overflow A | underflow A |
| Halite [% by wt.] | 60.1 | 3.7 | 77.1 |
| Sylvine [% by wt.] | 8.0 | 6.5 | 8.5 |
| Kainite [% by wt.] | 31.2 | 89.8 | 13.7 |
| | | Cyclone | Cyclone |
| | Feed B | overflow B | underflow B |
| Halite [% by wt.] | 61.7 | 8.5 | 86.7 |
| Sylvine [% by wt.] | 7.8 | 8.4 | 6.3 |
| Kainite [% by wt.] | 30.5 | 83.1 | 7.1 |

Trial A: Lower throughput (around 1.5 m³/h);
trial B: higher throughput (around 2.0 m³/h).

With reference to the sequential flotation, sylvine contents of around 62% and sylvine yields of >80% were obtained in the second fraction 24 in the second step, in the sylvine flotation concentrate fraction (laboratory trial), and the values obtained were therefore significantly higher by comparison with the values in the residue fraction of the kainite flotation in the first step.

The halite content of the second fraction 24, with values of around 25.9% (laboratory trial), is reduced significantly relative to the residue fraction of the kainite flotation. In production-scale trials for a continuous regime, as well, sylvine contents of around 61.4% and sylvine yields of around 84% were obtained in the second fraction 24 of the sylvine flotation. Here again, the halite content, with values of around 9.5%, is significantly reduced relative to the residue fraction of the kainite flotation. On the production scale, both the kainite flotation and the sylvine flotation each took place in two stages, while both flotation steps in the case of the laboratory trials were carried out each as one stage. With this method, it is also possible to combine the concentrate fractions from the first flotation stage 14, to give the kainite concentrate, and from the second flotation stage 22, to give the sylvine concentrate (second fraction), and therefore both concentrates 18 and 24 can be combined. This is represented by the return line 27. The method of sequential flotation therefore, by means of a simple reconditioning without substantial cost and complexity of apparatus, enables the recovery of considerable quantities of further useful substance, formed here by kainite and sylvine, with consequent significant technical, economic and environmental advantages. Table 5 shows the results of the sequential flotation for a continuous mode of operation.

TABLE 5
Results of two-stage sylvine flotation

| | Content | | Content | Yield |
|---|---|---|---|---|
| Mineral | conc. | Yield conc. | return | return |
| phase | [% by wt.] | [% by wt.] | [% by wt.] | [% by wt.] |
| Sylvine | 61.4 | 84 | 4.0 | 16 |
| Kainite | 29.1 | 65 | 6.0 | 35 |
| Halite | 9.5 | 3 | 90.0 | 97 |
| K₂O | 44.4 | 80 | 3.9 | 20 |

In terms of its embodiment, the invention is not confined to the preferred exemplary embodiment indicated above. Instead, a number of variations are conceivable, making use of the solution shown even with embodiments of a fundamentally different nature. All the features and/or advantages apparent from the claims, the description or the drawings, including construction particulars, spatial arrangements, and method steps, may be essential to the invention not only in themselves but also in a host of different combinations.

### LIST OF REFERENCE NUMERALS

100 treatment system
1 salt solution
10 evaporating device
11 crystallizate suspension
12 preliminary classifying device
13 kainite-reduced fraction
14 flotation device
15 kainite-enriched fraction
16 thickening device
17 useful kainite fraction
18 kainite concentrate
19 flotation residue
20 reservoir
21 reservoir
22 flotation device
23 first fraction
24 second fraction
25 reservoir
26 reservoir
27 return line

1: A method for treating a salt solution with a treatment system, wherein the treatment system comprises an evaporating device, the method comprising:
supplying the salt solution formed in an upstream operation to the evaporating device,
obtaining a crystallizate suspension comprising kainite, halite, and sylvine from the salt solution,
subsequently removing the kainite from the crystallizate suspension by at least the following steps:
supplying the crystallizate suspension to a preliminary classifying device, in which kainite is partly removed from the crystallizate suspension by a preliminary removal process based on the particle size of the kainite, to give a kainite-reduced fraction, and
transferring the kainite-reduced fraction to a flotation device, in which the remaining proportion of kainite is removed from the kainite-reduced fraction.

2: The method as claimed in claim 1, wherein the preliminary classifying device comprises a sorting spiral, wherein the removal of the kainite from the crystallizate suspension is performed by a preliminary removal process which is based on the particle size of the kainite, by the sorting spiral.

3: The method as claimed in claim 1, wherein the preliminary classifying device comprises a hydrocyclone, wherein the removal of the kainite from the crystallizate suspension is performed by a preliminary removal process which is based on the particle size of the kainite, by the hydrocyclone.

4: The method as claimed in claim 1, wherein the preliminary classifying device comprises an up-current classifier, wherein the removal of the kainite from the crystallizate suspension is performed by a preliminary removal process which is based on the particle size of the kainite, by the up-current classifier.

5: The method as claimed in claim 1, wherein a kainite-enriched fraction is transferred from the preliminary classifying device into a thickening device, in which liquid is taken off from the kainite-enriched fraction, so that a useful kainite fraction is taken out from the thickening device.

6: The method as claimed in claim 5, wherein the kainite-reduced fraction, before or in the flotation device, is supplied with an anionic flotation assistant and/or a kainite concentrate is taken out from the flotation device and supplied to the useful kainite fraction.

7: The method as claimed in claim 1, wherein a flotation residue comprising halite and sylvine is taken out from the flotation device and supplied to a further flotation device, in which a proportion of sylvine is removed from the flotation residue.

8: The method as claimed in claim 7, wherein the flotation residue from the flotation device, before or in the further flotation device, is supplied with a cationic flotation assistant.

9: The method as claimed in claim 7, wherein a sylvine-reduced and halite-enriched first fraction and a sylvine-enriched and halite-reduced second fraction are removed from the further flotation device, and/or the sylvine-enriched and halite-reduced second fraction is supplied via a return line to the useful kainite fraction and/or the sylvine-enriched and halite-reduced second fraction is supplied to a further, secondary treatment method.

10: A treatment system for implementing a method as claimed in claim 1, comprising:
a preliminary classifying device and a flotation device downstream of the preliminary classifying device, and/or
a further flotation device downstream of the flotation device.

11: The method as claimed in claim 6, wherein the anionic flotation assistant is a sulfated fatty acid or alkali metal salt thereof.

12: The method as claimed in claim 8, wherein the cationic flotation assistant is a primary amine.

13: The treatment system as claimed in claim 10, wherein the preliminary classifying device comprises at least one selected from the group consisting of a sorting spiral, a hydrocyclone, and an up-current classifier.

14: The treatment system as claimed in claim 10, wherein the treatment system further comprises a thickening device.
